(19) United States
(12) Patent Application Publication
(10) Pub. No.: US 2006/0033876 A1
(43) Pub. Date: Feb. 16, 2006

(54) Liquid crystal displays with post spacers, and their manufacture

(75) Inventors: Sung-il Park, Daegu City (KR); Lan French, Hove (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/538,279

(22) PCT Filed: Nov. 28, 2003
(86) PCT No.: PCT/IB03/05509

§ 371 Date: Jun. 10, 2005

(30) Foreign Application Priority Data
Dec. 14, 2002 (GB) 0229226.6

(51) Int. Cl. G02F 1/1339

(52) U.S. Cl. 349/155

(57) ABSTRACT

A post spacer (25) for a liquid crystal cell (26) is formed using colour filter material. At least a portion (15a) of the post spacer (25) and a corresponding pixel colour filter (15b) are defined from a layer of colour filter material (15) using photolithography, in which a photomask (8) comprising a pattern of transparent, half-tone and opaque regions is used to define structures with two different thicknesses t1, t2 simultaneously. The use of a half-tone photomask (8) allows the thickness of the post spacer portion (15a), and, therefore, the eventual height of the post spacer (25), to be defined independently of the thickness of the colour filter (15b). The post spacer (25) may be formed using half-tone photomasks (8) to define more than one layer of colour filter material (15, 23), allowing the ratio t1/t2 to remain within a predetermined limit. The post spacers (25) are preferably located away from thin film transistors (TFTs) (31) and at intersections of row and column electrodes (32, 33).

The invention relates to the structure and manufacture of a liquid crystal display apparatus. In particular, the invention relates to a method of forming a post spacer for a liquid crystal display device.

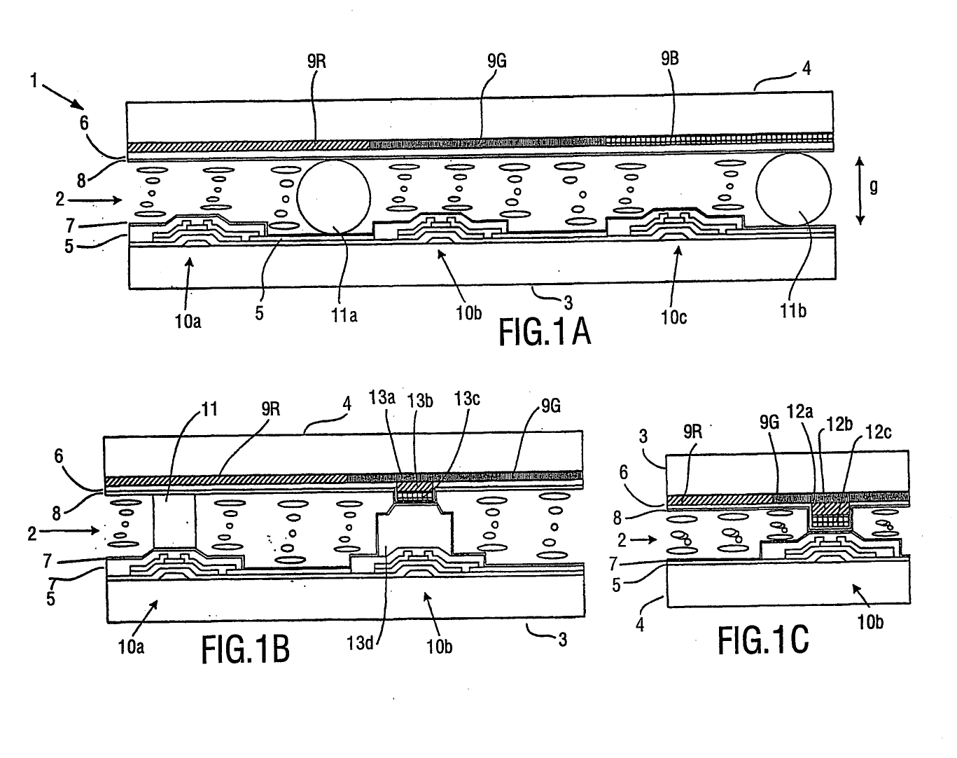

FIG. 1A depicts a prior active matrix liquid crystal display (AMLCD) device 1, comprising a liquid crystal 2 interposed between two glass substrates, 3, 4. The substrates 3, 4 carry Indium Tin Oxide (ITO) electrodes 5, 6, and alignment layers 7, 8 for defining the orientation of the liquid crystal molecules 2. Red, green and blue filters, 9R, 9G, 9B, are laminated on one of the substrates 4 and arranged to provide colour filters in an array of pixels. The pixels are driven by associated thin film transistors (TFT) 10a-10c, which are switched by row and column electrodes (not shown).

Ideally, the substrates 3, 4, should be arranged so that a gap g between them is constant across the pixel array, in order to provide uniform contrast levels. The gap g is maintained using spacer elements, such as ball spacers 11a, 11b or rod spacers (not shown) which are scattered between the substrates 3, 4. However, a number of problems have arisen with these types of spacers. As their locations in the liquid crystal display device 1 are essentially random, a uniform gap g cannot be guaranteed and the spacers may cluster, causing point defects. The distribution of ball spacers 11a, 11b may also cause the cell to be sensitive to touch. The alignment of the liquid crystal molecules may be distorted in the vicinity of a ball spacer 11a, causing light leakage problems, particularly in high resolution displays. Furthermore, the spacers 11a, 11b may partially block the pixel area, leading to loss of brightness, and may scratch the substrate 4 if the device 1 is subjected to a bending stress.

Ball spacers 11a, 11b may be acceptable for standard low resolution LCD displays, where the substrates 3, 4 may have thicknesses of 0.7 mm. However, their drawbacks become increasingly problematical in devices with large arrays of pixels, in-plane switching (IPS) displays, high contrast ratio panels and displays comprising thinner glass or plastic substrates. Precise spacing will also be required in fast response, narrow gap cells for LC-TV applications.

These problems have been addressed by the provision of post spacers 11, 12, 13 as shown in FIGS. 1B and 1C, which are laminated onto substrate 4 using a photomask or inkjet printing. This allows greater control over their positioning and over the uniformity of gap g. For example, the post spacers may located over the TFTs so that the pixel area is not obscured. The shape of the post spacers may also be tapered for similar reasons.

A post spacer 11 is formed using photolithography. The substrate 4 is coated with a 4 to 5 μm layer of a photosensitive polymer material, or photoresist. In a positive photolithographic process, the photoresist contains a photoactive additive that acts as a dissolution inhibitor but also absorbs light at one or more particular wavelengths, for example, light in the ultra-violet (UV) waveband. A photomask, configured with a pattern of areas that are transparent and opaque to light of a particular wavelength, is placed between the substrate and a UV light source and the photoresist is illuminated. On those parts of the substrate aligned with a transparent area of the photomask pattern, UV photons are absorbed at the top surface of the photoresist and the photoactive additive undergoes a photochemical reaction so that it no longer acts as a dissolution inhibitor. In addition, the UV photons bleach the exposed photoresist so that the light can pass through it and cause reactions deeper in the photoresist layer. Therefore, the photochemical reactions proceed through the photoresist layer in a “top-down” manner. The opaque areas in the photomask pattern shield parts of the photoresist layer from the UV light, so that these photochemical reactions do not occur.

The exposed portions of the photoresist layer, where the photoactive additive no longer inhibits dissolution, are removed using a developer solution and the substrate is cured. This process leaves portions of the photoresist layer in one or more locations on the substrate corresponding to the opaque areas of the photomask pattern, in this case at the desired location of the post spacer 11.

However, this process requires additional steps in the manufacturing process and is highly wasteful, as up to 99% of the polymer material applied to the substrate 4 may be removed. The costs associated with this type of structure compare unfavourably with those of ball or rod spacers.

One way of reducing such wastage is to use one or more layers of dyed photosensitive material to form the post spacer, as shown in FIG. 1C, where the same material is also used to form the filters 9R, 9G, 9B. This allows the formation of a post spacer portion during the photolithography steps used to define the colour filter material. Therefore, no additional photolithography steps are needed to form the post spacer, and this reduces the amount of discarded material. However, the height of the layers of the post spacer 12a, 12b, 12c, are dependent on the thickness of the filter layers 9R, 9G, 9B. The filter thickness is governed by the desired optical properties of the cell 1, such as brightness, and must be uniform across the pixel array, limiting the potential height of the post spacer. The filter layers are typically about 1.2 μm thick, which would lead to a post spacer height and cell gap of 2.4 μm or less, which is too small for most applications.

The dependence of post spacer height on filter thickness is demonstrated in U.S. Pat. No. 5,757,451. In this prior arrangement, any difference between the height of a post spacer portion and thickness of a corresponding filter arise only from the thickness of the photoresist applied to a particular location on a substrate at the beginning of the photolithographic process. The following example is based on the discussion in U.S. Pat. No. 5,757,451, which relates to a negative photolithography process, where photochemical reactions result in hardening of the exposed parts of the photoresist layer and the unexposed material is discarded during development. Presuming that the densities of the unhardened R, G and B photoresist are 20%, in a first step, an R filter is deposited by applying a 10 μm layer of photoresist, producing a 2 μm R filter and a 2 μm R post spacer portion. In a second step, a G filter is formed using a 10 μm layer of photoresist. Presuming the G photoresist layer is planarised, the thickness of the photoresist layer at the location of the post spacer would be only 8 μm, due to the presence of the R post spacer portion, resulting in a 2 μm G filter and a 1.6 μm G post spacer portion. In the third step, an 10 μm layer of B photoresist is applied and exposed, and presuming that the B photoresist layer is planarised, a 2 μm B filter and a 1.28 μm B post spacer portion is produced. In this example, the post spacer would provide a gap of 2.88 μm.

Furthermore, as the post spacer and filters are formed simultaneously, problems may arise when the post spacer is located above the TFT 10b, as in FIG. 1C. While this arrangement has the advantage of minimising obscuration of the pixel area, the ITO electrode layer 6 covering the post spacer is brought into close proximity with the TFT 10b. This may result in shorting and/or degradation of the TFT 10b.

It would be possible to overcome the dependency of the post spacer height on filter thickness by forming a post spacer combining layers of both colour filter material 13a, 13b, 13c and another polymer 13d, as shown in FIG. 1B. However, this would require a separate photoalignment and development step, eliminating any advantage arising from the use of the colour filter material.

An object of the present invention is to provide a method of forming a post spacer from colour filter material in which the thickness of the filter layers and the height of the post spacer can be controlled independently.

According to a first aspect of the invention, a method of forming a post spacer for a liquid crystal cell comprises depositing a first photosensitive colour filter material on a substrate, aligning a first photomask between the substrate and a light source, said first photomask comprising one or more regions that are transparent to the light produced by the light source, one or more regions that are opaque to said light and at least one half-tone, or grey tone, region, so that a desired location of the post spacer is shielded by an opaque region, exposing the first photosensitive colour filter material to said light and removing exposed first photosensitive colour filter material from the substrate.

In this manner, structures of different thicknesses that have been formed from the same layer of photosensitive colour filter material would be defined on the substrate. By using a half-tone mask exposure instead of a conventional photomask, the thickness of layers of colour filter material deposited at a post spacer location and at a filter location can be controlled independently and accurately. This allows the simultaneous formation of portions of the post spacer and the filters without restricting their relative dimensions, while reducing wastage.

Preferably, the first photomask is aligned with the substrate so that a desired location of a first colour filter is exposed to light transmitted through a half-tone region of the first photomask.

The method may further comprise defining a second layer of photosensitive colour filter material at the desired location of the post spacer using a second photomask. The second photomask may also comprise half-tone regions.

The invention further provides a post spacer formed using the above method and a display having a liquid crystal cell comprising such a post spacer. Preferably, the post spacers are positioned in the liquid crystal cell at locations away from TFTs. In particular, they may be provided at the intersections of rows and columns in a pixel array. However, if so required, the post spacers may be positioned over the TFTs.

According to a second aspect of the invention, a photomask for use in conjunction with a light source for forming a colour filter and at least part of a post spacer for a liquid crystal cell, comprises one or more regions that are transparent to the light produced by the light source, one or more regions that are opaque to said light and at least one half-tone region which transmits only a limited proportion of said light.

Embodiments of the invention will now be described, with reference to the accompanying drawings, in which:

FIGS. 1A, 1B and 1C show prior liquid crystal cells comprising prior spacers;

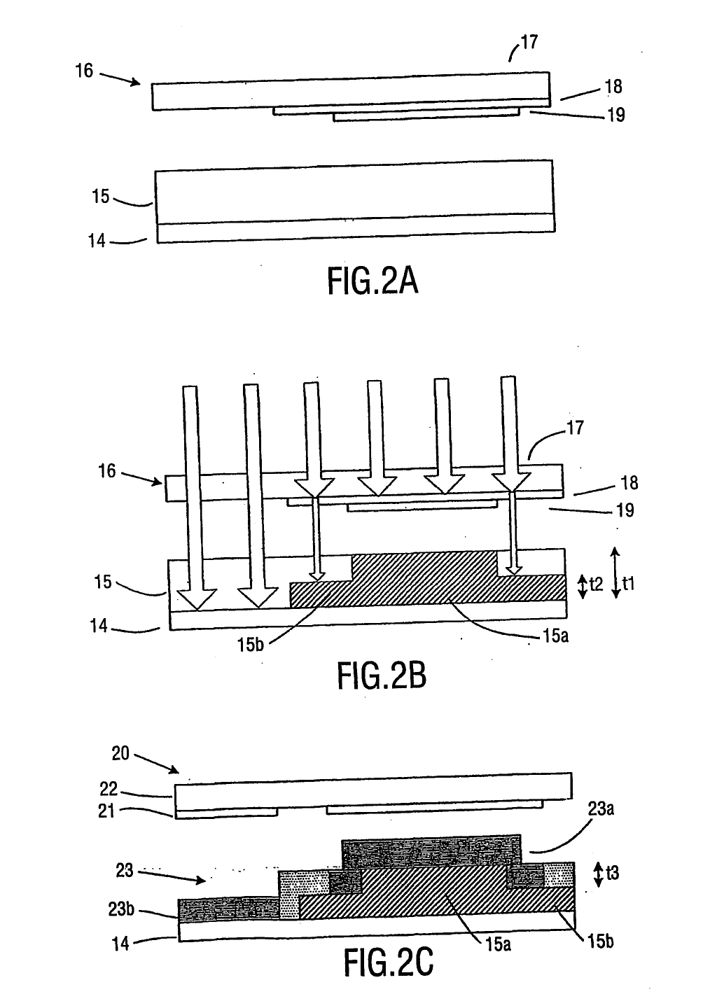

FIGS. 2A, 2B and 2C depict three stages in the manufacture of a post spacer according to the present invention;

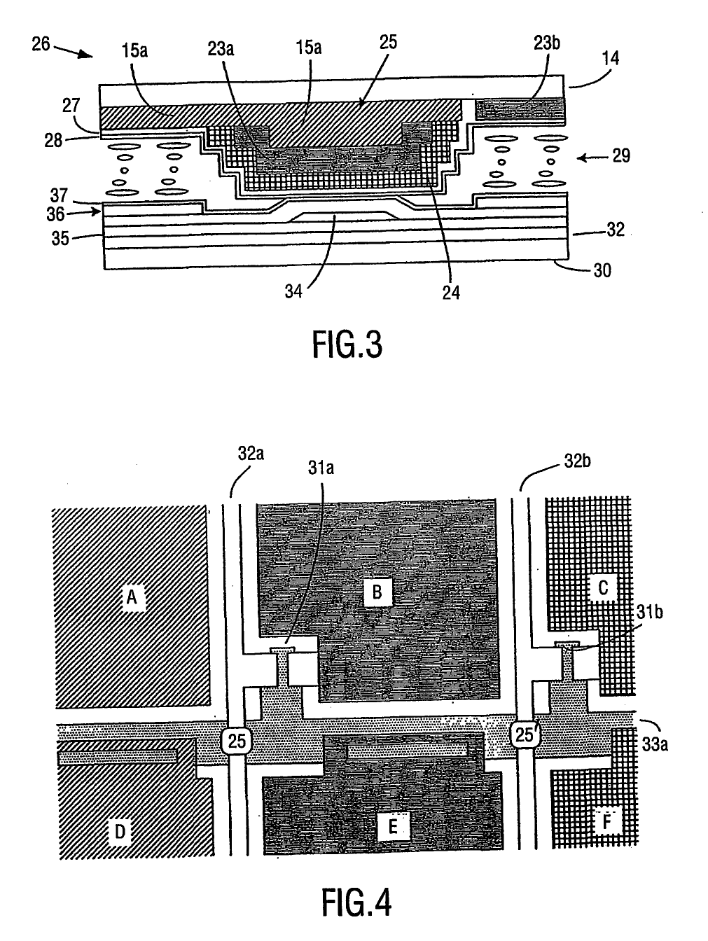

FIG. 3 shows an example of a liquid crystal cell comprising a post spacer according to the present invention;

FIG. 4 is a plan view of a pixel array in a liquid crystal display device; and

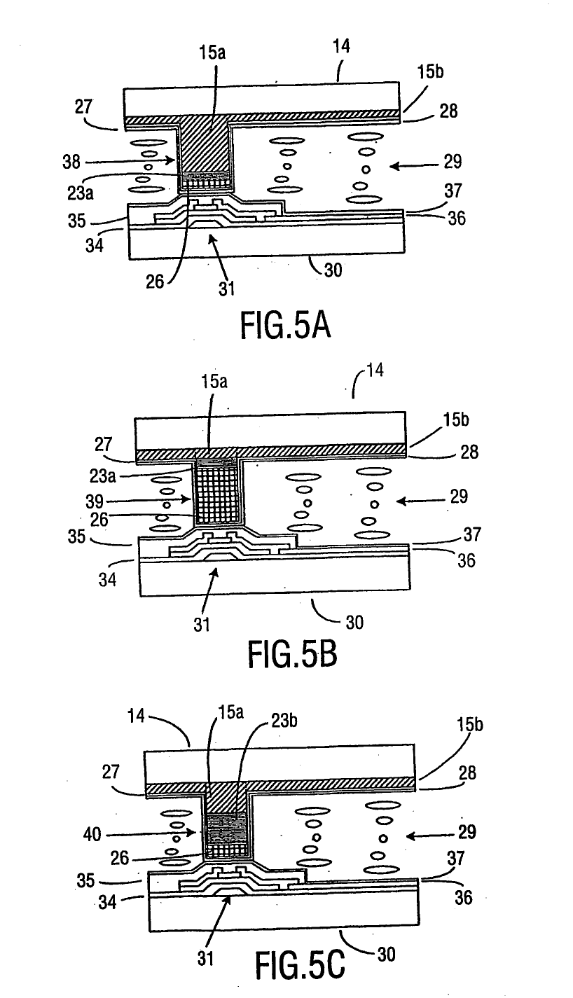

FIGS. 5A, 5B and 5C show further examples of post spacers according to the present invention.

FIG. 2A depicts a small portion of an insulating transparent substrate 14, such as an aluminosilicate glass. A post spacer is formed on the substrate 14 in the following process. The substrate 14 is coated with a first photopolymer 15, which has a dispersion of red pigment. In this example, the post spacer is formed by applying layers of red, green and blue photopolymers, although the order in which the various colours are applied to the substrate 14 is unimportant. The coloured portions are indicated in the figures using diagonal lines, shading and squares to indicate red, green and blue photopolymer material respectively.

The substrate 14 is aligned with a photomask 16, which comprises a plate 17 of material that is transparent to UV light, such as glass, an opaque layer 19 of chromium (Cr) and a, half-tone, or grey-tone, layer 18 of silicon-rich silicon nitride (SiN) through which UV light is transmitted but attenuated. The SiN and Cr layers 18, 19 are configured to provide a pattern of transparent, half-tone and opaque regions.

The substrate 14 is exposed to UV light as shown in FIG. 2B, in which the intensity of the UV light is indicated by the size of the arrows. Light from the UV source is transmitted through the transparent regions and attenuated by the half-tone regions, and interact with the red photopolymer 15 causing the photochemical reactions described above. However, as the regions of the red photopolymer layer 15 aligned with the half-tone regions of the photomask 16 are exposed to a reduced intensity of UV light, and the photochemical reactions proceed in a “top-down” manner, only the upper portions of the red photopolymer layer 15 are affected by the light exposure. The opaque regions shield underlying regions of the red photopolymer layer 15 from the UV light. The red photopolymer layer 15 is then developed and cured, removing the exposed regions of the red photopolymer layer 15.

A first red portion 15a of the red photopolymer layer 15, which was aligned with an opaque region of the photomask 16, remains on the substrate 14 and has a thickness t1. In the regions of the red photopolymer layer 15 aligned with the half-tone regions of the photomask 16, only the uppermost part of the red photopolymer layer 15 has been removed, leaving a second red portion 15b of reduced thickness t2.

The pattern of transparent, half-tone and opaque regions of photomask 16 is configured so that an array of red photopolymer portions 15a, 15b are left on the substrate. Red post spacer portions 15a with thickness t1 are provided at their desired locations. Red filters are provided by red portions 15b with thickness t2, deposited at locations corresponding to red pixels in the pixel array. In this manner, red filters 15b and portions of the post spacers 15a are formed simultaneously in which the height of the red post spacer portion 15a is not dependent on the thickness of the red filter 15b.

A second layer of photopolymer is then applied and exposed through a second photomask 20. FIG. 2C depicts the lamination of a layer of green photopolymer onto the substrate 14. In this example, the second photomask 20 does not include any half-tone regions, with opaque areas defined by a Cr layer 21 disposed on a transparent plate 22 as before. During development and curing, the exposed regions of the photopolymer, indicated by the dotted areas, are removed. Green photopolymer portions of thickness t3 remain, defining green filters post spacer portions 23a and green filters 23b. This process is repeated in order to form an array of blue filters and post spacer portions 24, shown in FIG. 3, completing the array of filters 15b, 23b (blue filter not shown) and post spacers 25.

FIG. 3 depicts a section of a liquid crystal cell 26 comprising a completed post spacer 25, while FIG. 4 is a plan view of the liquid crystal cell 26, showing part of the pixel array. Following the formation of the blue post spacer portion 24, the substrate 14 is coated with an indium tin oxide (ITO) layer 27, forming a continuous electrode, and a polyimide alignment layer 28, which is rubbed in order to define the desired orientation of liquid crystal molecules 29.

The substrate 14 is positioned facing a second substrate 30, which carries an array of back channel etched TFTs, 31a, 31b and a plurality of capacitors (not shown), where a TFT and capacitor is associated with each pixel area A-F. A matrix of row and column electrodes 32, 33 is provided so that a TFT 31 a can be activated by a row electrode 32a, causing its associated capacitor to be charged up according to the voltage on a column electrode 33a. The substrate 30 also carries SiN insulation and passivation layers 34, 35, an ITO electrode layer 36 and a rubbed polyimide alignment layer 37.

The post spacers 25, 25′ are positioned at the intersections of the row and column electrodes 32, 33. This permits the use of a structure in which parts of the ITO electrode layer 36 are removed from the post spacer areas, as shown in FIG. 3, without affecting the apertures of the pixels A-F. This arrangement therefore avoids the shorting and degradation problems associated with a number of previous liquid crystal cells where the TFTs 31a, 31b and the opposing ITO electrode layer 27 were positioned in close proximity to each other.

However, in an alternative embodiment, the post spacers may be placed over the TFTs 31, as shown in FIGS. 5A-5C. In these arrangements, the post spacers 38, 39, 40 are pillar shaped, as shown, or tapered, in order to avoid obscuring the pixel aperture. In FIG. 5A, a layer of red photopolymer has been used to produce regions of two different thicknesses, In a similar form to that shown in FIG. 2A. As before, part of a post spacer 38 is formed from red post spacer portions 15a with thickness t1 and red filters are formed from red portions 15b with reduced thickness t2. Layers of green and blue photopolymers, each with a uniform thickness, are laminated onto the substrate 14 to form green and blue filters and further portions of the post spacer 38.

In FIGS. 2A, 3 and 5A, the first of the photopolymer layers applied to the substrate 14, in this case the red photopolymer layer 15, is used to form an array of portions with different thicknesses. However, it is not necessary for the first photopolymer layer 15 to be used in this way as the second 23 and third photopolymer layers could be configured to leave portions of different thicknesses instead of, or in addition to, the first photopolymer layer 15.

FIG. 5B depicts a post spacer 39 that has been formed by applying the red and green photopolymer layers 15, 23 to form post spacer portions 15a, 23a and filters 15b, 23b, where t1=t2 for the red photopolymer layer 15 and the green photopolymer regions 23a, 23b have the same thickness t3. A blue photopolymer layer has been formed so as to provide a blue filter (not shown) and post spacer portion 26 with unequal thicknesses. It may be preferable to use the final photopolymer layer applied to the substrate 14 for defining structures with different thicknesses so that the substrate 14 and any overlying layers are as flat as possible when each of the photopolymer layers 15, 23 etc. are applied. This minimises variations in the thickness of the photopolymer layer due to underlying features and the resulting effects on the final post thickness.

The method of FIGS. 2A-C used a photomask 16 with half-tone regions to define portions with different thicknesses for only one of the photopolymer layers 15. While this procedure minimises the number of half-tone photomasks required, a particular application may require a large post spacer height and, where only a single half-tone mask is used, this leads to a large difference between t1 and t2. A better result may be produced where the ratio t1/t2 is kept below a certain value. This can be achieved by using half-tone photomasks 16 to define any two or all three of the photopolymer layers. For example, the post spacer 40 shown in FIG. 5C comprises red and green portions 15a, 23a formed with thicknesses exceeding those of their corresponding filters, e.g. 15b. A third portion 26 is formed from a uniform blue photopolymer layer, however, if required, a further half-tone photomask could be used to form blue filters (not shown) and post spacer portions 26 with differing thickness.

It should be noted that the term “aligned” has been used to indicated that a part of the substrate 14 receives light that has passed through, or has been shielded by, a particular region of the photomask 16 and that it is not necessary for the scale of the pattern defined on the substrate and the photomask pattern to be identical.

From reading the present disclosure, other variations and modifications will be apparent to persons skilled in the art. For example, the photomask pattern may be defined using different materials to form the half-tone and opaque regions, e.g. molybdenum silicide (MoSi) may be used to form the half-tone layer instead of SiN. Similarly, the opaque layer may be formed from molybdenum (Mo). It would also be possible to form the post spacer from a single portion of colour filter material 15b, subject to any limitations on the ratio t1/t2. Such variations and modifications may involve equivalent and other features which are already known in the design, manufacture and use of electronic devices comprising liquid crystal cells and component parts thereof and which may be used instead of or in addition to features already described herein.

1. A method of forming a post spacer for a liquid crystal cell, comprising:
depositing a first photosensitive colour filter material on a substrate;
aligning a first photomask between the substrate and a light source, said first photomask comprising one or more regions that are transparent to the light produced by the light source, one or more regions that are opaque to said light and at least one half-tone region, so that a desired location of the post spacer is shielded by an opaque region;
exposing the first photosensitive colour filter material to said light; and
removing exposed first photosensitive colour filter material from the substrate.

2. A method according to claim 1, wherein the first photomask is aligned with the substrate so that a desired location of a first colour filter is exposed to light transmitted through a half-tone region.

3. A method according to claim 1, further comprising:
depositing a second photosensitive colour filter material on
the substrate;
aligning a second photomask between the substrate and a light source, said second photomask comprising one or more regions that are transparent to the light produced by the light source and one or more regions that are opaque to said light, so that the desired location of the post spacer is shielded from the light by an opaque region of the second photomask;
exposing the second photosensitive colour filter material to light; and removing exposed second photosensitive colour material from the substrate.

4. A method according to claim 3, wherein the second photomask comprises half-tone regions and is aligned with the substrate so that a desired location of a second colour filter is exposed to light transmitted through a half-tone region.

5. A post spacer formed using the method of claim 1.

6. A display having a liquid crystal cell comprising one or more post spacers according to claim 5.

7. A liquid crystal cell according to claim 6, further comprising an array of pixels arranged in rows and columns, wherein the post spacer is located at a row/column intersection.

8. A liquid crystal cell according to claim 6, wherein the post spacer is located over a thin film transistor.

9. A photomask for use in conjunction with a light source for forming a colour filter and at least part of a post spacer for a liquid crystal cell, comprising one or more regions that are transparent to the light produced by the light source, one or more regions that are opaque to said light and at least one half-tone region which transmits only a limited proportion of said light.

10. A method of forming a post spacer for a liquid crystal cell, comprising:
depositing a first photosensitive colour filter material on a substrate;
aligning a first photomask between the substrate and a light source, said first photomask comprising one or more regions that are transparent to the light produced by the light source, one or more regions that are opaque to said light and at least one half-tone region;
exposing the first photosensitive colour filter material to said light;
removing exposed first photosensitive colour filter material from the substrate;
the first photomask is aligned with the substrate so that a desired location of a first colour filter is exposed to light transmitted through the half-tone region;
depositing a second photosensitive colour filter material on
the substrate;
aligning a second photomask between the substrate and a light source, said second photomask comprising one or more regions that are transparent to the light produced by the light source and one or more regions that are opaque to said light;
exposing the second photosensitive colour filter material to light; and
removing exposed second photosensitive colour material from the substrate;
wherein
the opaque regions of the first and second photomasks shield light to locate post spacers.
